(19) United States
(12) Patent Application Publication
(10) Pub. No.: US 2003/0067672 A1
(43) Pub. Date: Apr. 10, 2003

(54) Programmable gain clamped and flattened-spectrum high power erbium-doped fiber amplifier

(76) Inventors: George Bodeep, Suwanee, GA (US); Dong-Xue Wang, Alpharetta, GA (US)

Correspondence Address: ARRIS International, Inc., 11450 Technology Circle, Duluth, GA, 30097, US

(21) Appl. No.: 10/268,807

(22) Filed: Oct. 10, 2002

Related U.S. Application Data
(60) Provisional application No. 60/328,344, filed on Oct. 10, 2001.

(51) Int. Cl. H01S 3/00

(52) U.S. Cl. 359/341.4

(57) ABSTRACT

A fiber amplifier using a single, general-purpose, fixed, gain-flattening filter to provide a flattened response with respect to wavelength for the C-Band. A feedback loop comprises a micro controller that maintains the amplifier in a selected gain-clamped mode. This facilitates use in a variety of networks that may use a variety of different types and brands of equipment. The micro controller varies the bias current of a first laser pump and a second laser pump in response to input received from an input monitor and an output monitor so that the overall selected composite power gain is maintained.

An iterative process determines the attenuation function of the filter based on amplifier parameters for each of the selectable gain modes. The determined attenuation functions corresponding to each of the modes are mathematically averaged; the result being the overall attenuation function of the filter. An interface allows selection of desired gain modes.

### CROSS REFERENCE TO RELATED APPLICATION

This application claims the benefit of priority under 35 U.S.C. 119(e) to the filing date of Wang, et al., U.S. provisional patent application No. 60/328,344 entitled “Programmable Gain Clamped And Flattened High Power Erbium-Doped Fiber Amplifier”, which was filed Oct. 10, 2001, and is incorporated herein by reference.

### FIELD OF THE INVENTION

This invention relates, generally, to optical communication networks and, more particularly, to the transfer characteristics of erbium-doped fiber amplifiers.

### BACKGROUND

Rare-earth elements, preferably erbium, have been used to dope fiber for use in optical fiber amplifiers. These amplifiers are often used in optical networks using wavelength division multiplexing (“WDM”) for increasing the amount of information that can be propagated in a fiber, as different wavelengths may be used for transmitting separate information signals in the same fiber.

In such a system, it is desirable to have the gain of the amplifier be as flat as possible over the spectrum of wavelengths transmitted so that each wavelength, or channel, of information is transmitted with equal power as the next. However, erbium doped fiber often boosts the gain of certain wavelengths over others of signals being amplified. This is due to an inherent phenomenon of erbium fiber amplifiers known in the art as Amplified Spontaneous Emission (“ASE”). Available amplifier power may be wasted because amplifiers and re-amplifiers in a given network can only spaced as far apart as dictated by the weakest channel transmitted, thus requiring more amplifiers in a given network than would be used if power loss were minimized with a flat transfer characteristic of amplifiers.

In attempting to achieve greater gain flatness of the transfer function of fiber amplifiers, devices known in the art as gain-flattening filters have been used. These filters are typically used to equalize, or flatten, the ratio of output power to input power of the amplifier with respect to wavelength. The types of filters used may include thin-film, etched-cladding or acustooptic filters. The thin film and the etched cladding types, for example, are typically fixed with respect to transfer characteristic. While fixed filters may have provide acceptable performance when tuned for a specific installation, a given amplifier optimized for use in one application would not typically be optimized for use in another. Acustooptic filters provide some degree of gain flatness and tunability, but are relatively costly as compared to fixed filters and are more complicated to implement, in addition to slower response time and higher noise figures (“NF”).

Therefore, there is a need for a gain flattened fiber amplifier that is lest costly to manufacture and implement that one that uses a tunable acustooptic filter, while having the capability to provide acceptable performance and be easily integrated into a wide variety of network applications. Furthermore, there is a need for an amplifier that can provide gain flattening across a broad spectrum (typically at least the spectrum known in the art as the C-band ranging from 1530-1560 nM), while wide input-power dynamic range.

### SUMMARY

It is an object to provide a gain flattening fiber amplifier that operates in a plurality of selectable gain-modes, the different modes corresponding to a plurality of different gain ratios.

Moreover, it is an object to provide an amplifier having a plurality of operating-gain modes that are easily selectable by a user, such as an installer or network operator, for example. This allows the fiber amplifier to be used with a wide variety of network components and to be easily integrated into a network that may comprise components from a variety of manufacturers.

Furthermore, it is an object to provide a fiber amplifier that can accept input power levels over a wide dynamic range while maintaining the flattened gain clamped at a selectable predetermined ratio.

It is still another object to provide a method for determining gain flattening filter characteristics of a single, low-cost, general-purpose gain-flattening filter that provides a best-fit attenuation function for a plurality of selectable operating gain modes.

It is yet another object to provide a method of operating a gain-clamped flattened-spectrum fiber amplifier so that a constant overall composite output power versus composite input power is maintained over the C-Band of wavelengths.

### BRIEF DESCRIPTION OF THE DRAWINGS

FIG. 1 illustrates an erbium-doped fiber amplifier with a means for selectively programming the gain of the amplifier.

FIG. 2 illustrates a typical attenuation function for a general purpose gain-flattening filter wherein the attenuation function is similar to a fiber amplifier's transfer function so that the gain through the amplifier is flattened.

FIG. 3 illustrates the gain transfer function through a selectable gain-clamped fiber amplifier at each of three selectable gain values.

FIG. 4 illustrates the gain functions and noise figures for three different amplifier arrangements, including a single stage pump, a dual stage pump and a dual stage pump with a gain-flattening filter.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof. Furthermore, while some aspects of the present invention are described in detail herein, no specific conductor or fiber type, integrated circuit, discrete component, connector, enclosure, power supply, circuit board arrangement, capacitor or resistor value, or fuse rating, for example, is required to be used in the practicing of the present invention. Indeed, selection of such parts and components would be within the routine functions of a designer skilled in the art.

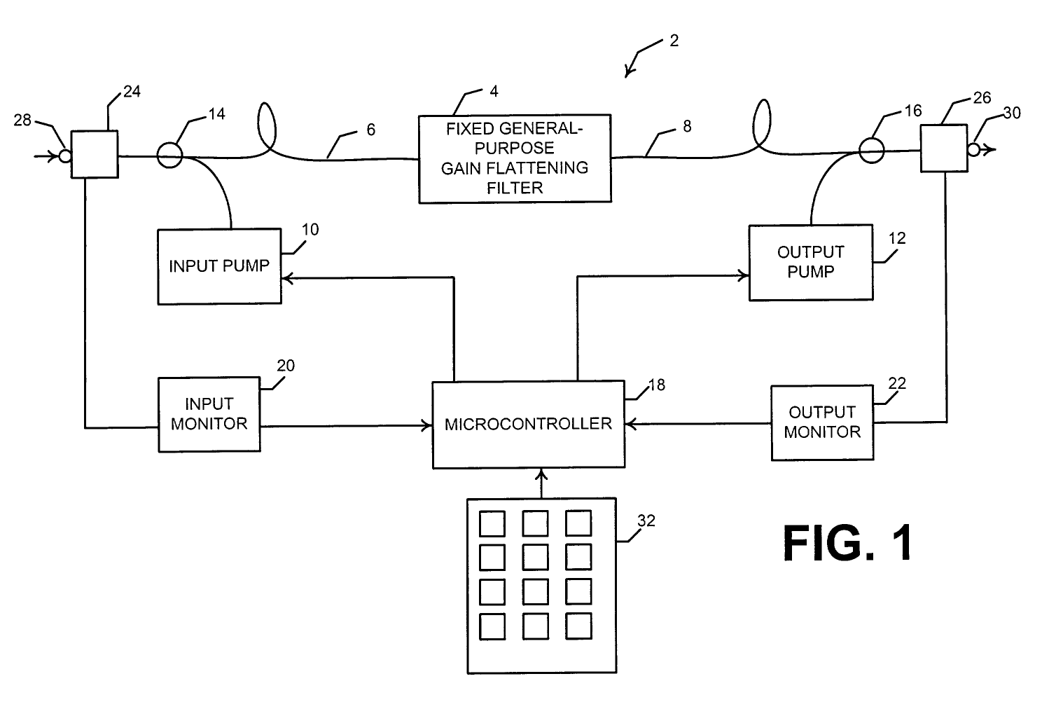

Turning now to the figures, FIG. 1 illustrates a fiber amplifier 2 with a means for selectively programming the gain of the amplifier. The amplifier comprises a gain-flattening filter 4 for compensating for the non-flat transfer characteristics that are typically inherent in fiber amplifiers. The gain-flattening filter 4 is disposed inline between an input fiber 6 and an output fiber 8. Erbium is preferably used to dope fibers 6 and 8, although other doping materials may be used. It is appreciated that different doping materials may cause different transfer function characteristics, so the attenuation response of the gain-flattening filter 4 is typically tailored to compensate for inherent peaks and valleys of a given amplifier's transfer characteristic.

Driving the amplifier 2 is an input pump 10 and an output pump 12, the input pump being coupled to input fiber 6 by input directional coupler 14 and the output pump being coupled to the output fiber 8 by output directional coupler 16. The input pump 10 and the output pump 12 are controlled by micro controller 18, which can automatically adjust the bias power of each of the pumps individually yet simultaneously. Micro controller 18 adjusts the bias power of the pumps based on signals received from input monitor 20 and output monitor 22. Input monitor 20 and output monitor 22 may typically comprise optical-electrical converters that receive optical signals from input power detector 24 and output power detector 26 respectively. Input power detector 24 and output power detector 26 may each typically comprise a PIN diode or other optical sensor known in the art. Input power detector 24 detects the power of an optical signal that is received by amplifier 2 at input port 28 and output power detector 26 detects the power of the output signal from the amplifier at output port 30.

Signals received by micro controller 18 from output monitor 22 and input monitor 20 are used by the micro controller to maintain a constant, predetermined ratio of output power to input power, or gain, as determined based on the power levels detected by output detector 26 and input detector 24. The predetermined gain ratio is selectable by providing an input representing the desired gain into interface 32. This selectable gain feature facilitates use of the amplifier 2 in a wide variety of networks, as opposed to an amplifier that does not provide a selectable gain feature, because the gain of amplifier 2 can be easily adjusted to closely match power level requirements of the rest of a network in which it is to be used.

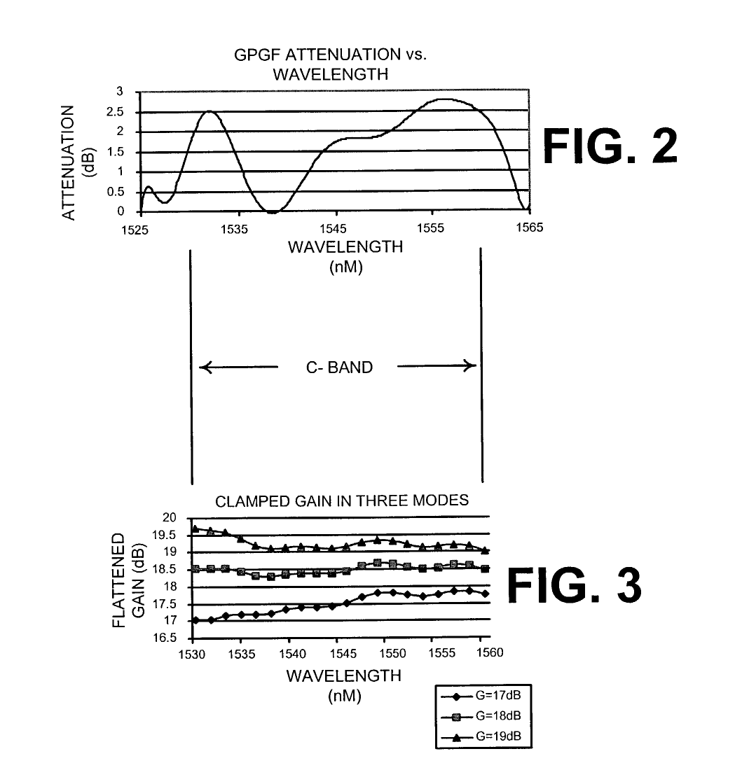

To illustrate the transfer characteristic for which the gain-flattened filter aspect should compensate, FIG. 2 illustrates a typical attenuation of a general purpose gain flattening filter that is used to compensate for the gain response of an unfiltered erbium-doped fiber amplifier. As will be apparent to those skilled in the art, a filter should have an attenuation transfer function that mirrors the transfer characteristic shown in FIG. 2 (or in other words, a gain transfer characteristic that is the inverse of the amplifier's inherent gain transfer characteristic) to achieve gain flatness with respect to spectrum wavelength. It is noted that the transfer characteristic shown in FIG. 2 has amplitude variations as great as 3 dB within the C-band range.

FIG. 3 illustrates the transfer function through the fiber amplifier 2 of FIG. 1 at three different operating modes, where the gain has been flattened using a single customized general purpose gain-flattening filter. The operating modes correspond to clamped gains of 17 dB, 18 dB and 19 dB over the desired spectrum. It will be appreciated that the gain flattened transfer function of amplifier 2 varies by less than 0.7 dB trough for all three clamped-gain operating modes over the C-Band range, including wavelengths as short as 1530 nM. Moreover, the curves illustrated result from a composite, or total input power of 3 dBm. However, test results showed that the same transfer functions would result at the three clamped gain modes for any total input power that varies over a range between −7 dBm and 3 dBm, resulting in a usable dynamic input range of 10 dB. Thus, the effective range is extended below 1540 nM, which is often the lowest wavelength that is typically usable from a non-flattened amplifier.

To determine the transfer function of a filter that will provide counter-acting attenuation that will flatten a given amplifier's inherent transfer characteristic, an iterative process is used. The process measures the baseline output power of the amplifier versus the input power applied to it for a given desired gain ratio over the desired spectrum. The test data results from this iterative process are used to populate a three dimensional matrix having parameters of input power versus gain ratio versus wavelength. Fiber vendors typically provide software that is used to determine the inherent transfer function of a particular amplifier, and hence the required fixed filter attenuation function that will flatten the amplifier's characteristics. Since the measured parameters that are used to determine the transfer function of an amplifier, and thus the attenuation function needed to provide a flat response through said amplifier, are known in the art, they are only briefly mentioned, and include: fiber length, pump power, pump wavelength, input power, inter-stage loss, coupling loss at the input and output fibers and temperature, among others.

It will be appreciated that changes in pump power and changes in filter equalization curve will result in corresponding changes in ASE. Thus, the iterative process must take into account changes caused by the equalization curve, which is being determined by the iterative process, as well as anticipated variations in pump power.

After transfer function characteristics have been established during a baseline first iteration corresponding to a first fixed overall gain, the same process is followed for other fixed gain ratios. Thus, multiple iterations may be performed for a single filter application at different proposed overall gain ratios. If an equalization curve for three preferred overall gain values, for example, are to be determined, three different two dimensional matrices would be produced, each one corresponding to one of the different preferred gain ratios. When combined together, these three two-dimensional matrices would result in the before-mentioned three-dimensional matrix. The three dimensional matrix could then be manipulated using mathematical techniques known in the art, to determine a resultant two dimensional array having parameters of gain versus wavelength. The mathematical technique for manipulating the three-dimensional matrix is chosen to produce a resultant two-dimensional array that is a best-fit approximation of any one of the three two-dimensional arrays that make up the before-mentioned three-dimensional matrix. From the two-dimensional best-fit approximation array, a single, general purpose, fixed gain-flattening filter is produced. This resultant filter is filter 4 as shown in FIG. 1. Thus, a single, low cost, fixed, general-purpose gain-flattening filter, as compared to a relatively more expensive tunable acustooptic filter, for example, can be used to provide flat response across the entire C-Band.

Moreover, the less costly, single, general-purpose filter can be used to provide essentially flat response for multiple clamped-gain modes. Although the general-purpose fixed filter element itself is not tunable, it can be used in amplifier 2 to flatten the amplifier's gain with respect to wavelength for a plurality of selectable overall gain modes. Thus, the result is an inexpensive amplifier 2 that is customizable to accommodate a wide variety of applications using a similarly wide variety of types and brands of network equipment. Though less expensive than an amplifier that uses a tunable filter, the performance of amplifier 2 can still provide acceptable performance, i.e., gain that is flat within 1.0 dB or less. This is because the filter transfer function is mathematically determined to provide a best-fit average of the specific transfer functions determined at each of a plurality of preferred gain levels, for example, 17, 18 or 19 dB.

Furthermore, amplifier 2 can accept signals having an input power falling within a range of at least 10 dB, as the micro controller 18 can continuously adjust the individual bias power of pumps 10 and 12 so that the output power capability of pump 12 is not exceeded, while maintaining the power of pump 10 at a level just below its maximum. For example, in a preferred embodiment, co-propagating pump 10 operates at λ=980 nM to provide high bias-current-to-photon conversion and a low noise figure, although the optical signal conversion efficiency is lower than for a pump operating at λ=1480 nM. To complement the characteristics of pump 10, counter-propagating pump 12 operates at λ=1480 nM. Operating at this wavelength, pump 12 provides high optical conversion efficiency, but may trade off some conversion efficiency of bias-current-to-optical power. Micro controller 18 is configured to default to the condition where pump 12 is at unity gain. Bias current to pump 10 is increased until it has reached its limit. Then, the bias current to pump 12 in increased until the desired overall gain from amplifier 2 is achieved.

Together, pumps 10 and 12 help amplifier 2 to economically provide a wide dynamic range for input signals; the cost of both pumps together will typically be less than the cost of a single pump that provides the performance of amplifier 2. In addition, the dual-stage design comprising pumps 10 and 12 consumes less power for the same output power, as compared to an amplifier that uses a single stage design. This is because the flattening attenuation function, which typically converts attenuated energy into heat, is applied to the signal before it is amplified by pump 12, the pump that provides most of the bias-current-to-photon conversion functionality. Having been processed through filter 4, the magnitude of a signal applied to pump 12 varies only slightly with respect to frequency. Thus, power waste is reduced because excess power is not produced by pump 12 at wavelengths that have inherently high gain in order to provide acceptable minimum output power at the wavelengths having lower inherent gain.

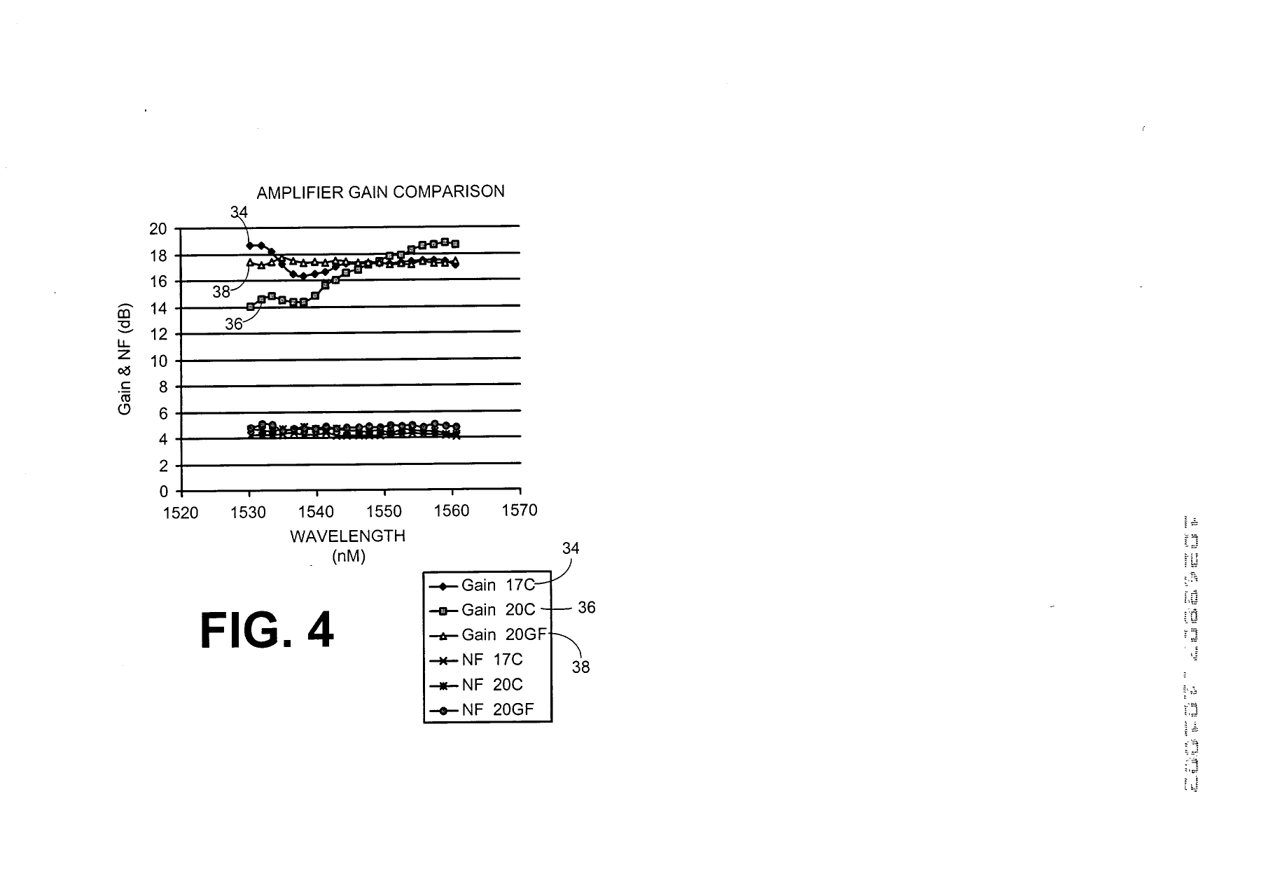

Turning now to FIG. 4, a chart shows characteristics of three different amplifier arrangements and compares their transfer functions. Plot line 34 represents the gain transfer function of a single-stage co-propagating light pump having a nominal overall maximum gain of 17 dB. A pump that provides this level of performance is available in the art and is typically low cost, as compared to other single stage pumps that, standing alone, may have a higher maximum gain, for example 20 dB. Plot line 36 represents a dual pump arrangement using a co-propagating and a counter propagating pump, each pump being the low cost type mentioned above that has a transfer function represented by plot line 34. It will be appreciated that this arrangement provides a higher maximum gain than the single stage arrangement. However, the transfer function is not as flat. Plot line 36 indicates that the gain versus wavelength of this arrangement varies from approximately 14 dB at 1530 nM, to approximately 19 dB at 1560 nM, a variance of 5 dB.

To improve this amplifier performance, a gain-flattening filter according to the preferred embodiment results in a transfer characteristic as illustrated by plot line 38. A gain-flattening filter designed according to the process herein described is used in conjunction with the low-cost-pump dual-stage design, the transfer function of which is illustrated by plot line 36. As shown in the figure, when the gain-flattening filter is used with the low-cost-pump dual-stage design, the gain, as illustrated by plot line 38, varies by less than 1 dB.

What is claimed is:

1. A programmable gain-clamped flattened-spectrum erbium-doped fiber amplifier comprising:
a filter means for flattening the gain of an output signal versus an input signal with respect to wavelength;
an interface means for selecting a desired overall gain;
means for measuring the signal strength of the input signal and providing an input measurement based thereon;
means for measuring the signal strength of the output signal and providing an output measurement based thereon;
a controller means for controlling the bias currents of an input pump and an output pump to maintain the selected desired overall gain based on the input measurement and the output measurement.

2. The amplifier of claim 1 wherein the input signal measuring means measures the input signal strength in the optical path before the injection point of the input pump.

3. The amplifier of claim 1 wherein the output signal measuring means measures the output signal in the optical path after the injection point of the output pump.

4. The amplifier of claim 1 wherein the controller is a micro controller arranged in a feedback loop that receives the input measurement, the output measurement and a desired gain signal from the interface means, and to provide an input gain regulation signal to the input pump and an output gain regulation signal to the output pump in response to said received input measurement, output measurement and desired gain signal so that the overall amplifier gain equals the selected desired gain.

5. The amplifier of claim 1 wherein the input pump is a laser diode.

6. The amplifier of claim 1 wherein the output pump is a laser diode.

7. The amplifier of claim 1 wherein a best-fit attenuation function for the gain-flattening-filter is determined by an iterative process that calculates the gain of the amplifier with respect to wavelength based on data corresponding to a set of parameters that includes: length of erbium fiber, input pump power, output pump power, input pump wavelength, output pump wavelength, input power, inner stage losses, coupling losses at an input to the amplifier and an output of the amplifier, ambient temperature surrounding the amplifier and the attenuation function itself.

8. The amplifier of claim 7 wherein a gain-specific attenuation function is separately determined for each of a plurality of fixed overall gain mode values by evaluating the set of parameters at each of the plurality of gain mode values, the best-fit attenuation function being determined by mathematically calculating a best fit overall attenuation function based on the plurality of gain-specific attenuation functions.

9. A method for determining a best-fit overall attenuation function of a gain-flattening filter for use in a gain-clamped flattened-spectrum fiber amplifier comprising:
determining for each of a plurality of gain mode values an attenuation function that flattens the inherent transfer function characteristics of the fiber amplifier; and
averaging the plurality of attenuation functions corresponding to the plurality of gain mode values using a mathematical process.

10. A method for operating a gain-clamped flattened-spectrum fiber amplifier comprising:
applying to each of a first laser pump and a second laser pump an operating bias current equal to the threshold current of each respective laser pump;
increasing the operating bias current to the first pump until either a desired overall amplifier gain is achieved or the first pump's maximum output is reached; and
increasing the operating bias current to the second pump until the desired overall amplifier gain is achieved or the second pump's maximum output is reached, if the desired overall gain was not achieved by increasing the operating bias current to the first pump.

11. The method of claim 10 wherein the first laser pump operates at 980 nanometers.

12. The method of claim 10 wherein the second pump operates at 1480 nanometers.
